(19) United States
(12) Patent Application Publication
(10) Pub. No.: US 2004/0102995 A1
(43) Pub. Date: May 27, 2004

(54) Method and system for modeling sales processes

(76) Inventor: Prasad Boppana, Houston, TX (US)

Correspondence Address: MCANDREWS HELD & MALLOY, LTD, 500 WEST MADISON STREET, SUITE 3400, CHICAGO, IL, 60661

(21) Appl. No.: 10/716,282

(22) Filed: Nov. 18, 2003

Related U.S. Application Data
(60) Provisional application No. 60/427,582, filed on Nov. 19, 2002.
(60) Provisional application No. 60/427,588, filed on Nov. 19, 2002.
(60) Provisional application No. 60/427,602, filed on Nov. 19, 2002.
(60) Provisional application No. 60/427,397, filed on Nov. 19, 2002.

(51) Int. Cl. G06F 17/60

(52) U.S. Cl. 705/1; 705/10

(57) ABSTRACT

Certain embodiments of the invention may be found in a method and system for modeling sales processes and may comprise acquiring sales process information related to at least one existing business model and defining one or more parameters that may be utilized to characterize a practice related to one or more existing or hypothetical business models. Accordingly, rules may be created based on one or more defined parameters which identifies one or more of the best practices. The created rules may then be utilized to model a new sales process. Rules from best practices may be adaptively combined with one or more received manual inputs. A created rule may be generic and therefore, applicable to a plurality of contexts. A created rule may be specific and applicable to a particular context. Generic and/or specific rules may be combined and utilized to model a sales process.

### CROSS-REFERENCE TO RELATED APPLICATIONS/INCORPORATION BY REFERENCE

This application makes reference to, claims priority to and claims the benefit of U.S. Provisional Application Serial No. 60/427,582 (Attorney Docket No. 14137US01) filed on Nov. 19, 2002.

This application also makes reference to:

U.S. Provisional Application Serial No. 60/427,588 (Attorney Docket No. 14132US01) filed on Nov. 19, 2002;

U.S. Provisional Application Serial No. 60/427,602 (Attorney Docket No. 14133US01) filed on Nov. 19, 2002; and

U.S. Provisional Application Serial No. 60/427,397 (Attorney Docket No. 14136US01) filed on Nov. 19, 2002.

All of the above stated applications are hereby incorporated herein by reference in their entirety.

### FIELD OF THE INVENTION

Certain embodiments of the invention relate to sales automation in a business environment. More specifically, certain embodiments of the invention relate to a method and system for modeling sales processes.

### BACKGROUND OF THE INVENTION

The pervasiveness of information technologies along with data transfer media such as the Internet, have provided an excellent opportunity for customers to tap into a diverse range of services and products and for businesses to provide the necessary products and services to meet customer demands. In this regard, e-business and e-commerce solutions have revolutionized business practices over the past few decades.

Notwithstanding the advantages provided by e-business, e-commerce and various other related information methodologies and technologies, there is a general lack of consolidated sales process information. In general, sales process information may encompass any information and/or tasks that are required to identify a customer need, up to and including any information and/or tasks necessary to consummate a sale. For example, sales process information may include information such as customer needs, customer requirements, customer business and financial data, and past and present customer practices, etc. Current sales paradigms require sellers to access myriad systems in order to acquire necessary sales process information to satisfy their business requirements.

A “seller” may refer to an entity sourcing goods and/or services, while a “buyer” may be any entity that receives goods and/or services from, for example, a “seller.” Accordingly, depending on which entity is sourcing goods or services in a particular transaction, an entity may be a “seller” in one transaction but be a “buyer” in a subsequent transaction. Similarly, depending on which entity is receiving goods and/or services in a particular transaction, an entity may be “buyer” in a particular transaction, and a “seller” in a subsequent transaction. Additionally, a similar definition may apply to a customer depending on whether a customer is receiving goods and/or services, or sourcing goods and/or services.

The general lack of consolidated information means that sellers typically have to access, for example, a plurality of databases, which may be hosted by a plurality of disparate systems, often requiring various access interfaces and/or methodologies. In this regard, depending on information complexity and volume, a seller may require specialized knowledge and training to access multiple systems in order to acquire relevant sales process information necessary to sell its products and/or services. Specialized knowledge and training comes at a price, which is often reflected in the cost of the produced goods or service offerings.

In many instances, a large portion of the acquired sales process information may be irrelevant to the context of the seller's requirements, and hence unusable. Additionally, since sales process information may be stored in various disparate repositories, integration of information may be difficult and in certain cases, may not be readily accessible. Accordingly, not only is the accessibility of information difficult, but general availability and discovery of information may also be severely impacted. The current sales paradigm is not only inefficient, but may often prove to be quite costly since vast amounts of time may be spent searching for pertinent sales process information. Furthermore, even after the sales process information has been received, there are still problems associated with how the sales process information may be effectively utilized.

In general, it has been noted that in most businesses, about 20% of the sales force may be classified as top performers, while the remaining 80% of the sales force operate at average or below average performance. It would be beneficial and productive to have a method and system which may provide a more equitable performance distribution.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for modeling sales processes. In an embodiment of the invention, a sales process may be modeled by acquiring sales process information related to at least one existing business model. At least one parameter that characterizes at least one best practice related to one or more existing or hypothetical business models may be defined. At least one rule may be created based on one or more defined parameters identifying one or more best practices. Accordingly, one or more of the created rules may be utilized to model a new sales process.

The modeling of a sales process may further comprise adaptively combining rules from a plurality of best practices with one or more manual inputs. In accordance with an aspect of the invention, a created rule may be generic and therefore, applicable to a plurality of contexts. In an alternative aspect of the invention, a created rule may be applicable to a specific context. Notwithstanding, at least one generic rule and/or at least one specific rule may be combined and the combined rule may be utilized to model a sales process. At least one real-time update may be received from at least one information source and utilized to modify at least one of the created rules. The modification of the rule by the real-time update may be adapted to occur dynamically.

The method may further comprise, generating by analogy, at least one option or suggestion which may be utilized for creating the rule. At least one fragment of sales process information may be identified and/or selected to be utilized for generating the rule by analogy. The fragment of sales process information may be identified and/or selected based upon a context associated with the fragment of sales process information. In another aspect of the invention, at least one input received context may be utilized for identifying and/or selecting the fragment of sales process information.

Another aspect of the invention may also provide a machine readable storage, having stored thereon a computer program having at least one code section for modeling sales processes. The at least one code section may be executable by a machine for causing the machine to perform the steps as described above for modeling sales processes.

Aspects of the system for modeling sales processes may comprise a sales process server that acquires sales process information from at least one existing business model and defines at least one parameter that characterizes at least one best practice related to at least one existing business model. A sales process rules engine may create at least one rule based on the defined parameter which identifies the best practice. A sales process modeler may model a new sales process utilizing the created rule. A sales process discoverer may adaptively combine rules from a plurality of best practices and/or at least one manual input to execute modeling of the new sales process. The created rule may be a generic rule that may be applicable to a plurality of contexts or a specific rule that may be applicable to a particular context.

The sales process server may be adapted to receive at least one real-time update from at least one information source and a sales process rules engine may modify the at least one created rule based on at least a portion of the real-time update. The sales process rules engine may dynamically modify at least one of the created rules in real-time. In another aspect of the invention, the sales process rules engine may generate by analogy, at least one option or suggestion which may be utilized for creating the rule. A sales process discoverer may identify and/or select at least one fragment of sales process information to be utilized for generating the rule analogy. The sales process discoverer and/or the sales process engine may identify and/or select at least one fragment of sales process information based on a context associated with the fragment of sales process information. The sales process server may receive at least one input received context that may be utilized to identify and select the fragment of sales process information.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a sales processing system having an exemplary sales integration engine in accordance with an embodiment of the invention.

FIG. 1a is a block diagram of an exemplary data synchronization block in accordance with an embodiment of the invention.

FIG. 2 is a block diagram of an exemplary sales process in accordance with an embodiment of the invention.

FIG. 3 is a block diagram of an exemplary sales process configurator that may be utilized for sales process configuration in accordance with an embodiment of the invention.

FIG. 4 is a block diagram of an exemplary system that may be utilized for sales process configuration system in accordance with an embodiment of the invention.

FIG. 5 is a flow chart illustrating exemplary steps outlining the operations of a sales process modeler in accordance with an embodiment of the invention.

FIG. 6 is an exemplary GUI illustrating manual copying of activities and steps for sales process modeling in accordance with an aspect of the invention.

### DETAILED DESCRIPTION OF THE INVENTION

Certain embodiments of the invention may be found in a method and system for modeling sales processes. Aspects of the method may include acquiring sales process information related to at least one existing business model and defining one or more parameters that may be utilized to characterize a practice related to one or more existing or hypothetical business models. Accordingly, rules may be created based on one or more defined parameters which identifies one or more of the best practices. The created rules may then be utilized to model a new sales process. Rules from best practices may be adaptively combined with one or more received manual inputs. A created rule may be generic and therefore, applicable to a plurality of contexts. A created rule may be specific and applicable to a particular context. Generic and/or specific rules may be combined and utilized to model a sales process. Real-time updates may be received from at least one information source and utilized to modify the created rules. This modification of the rules may be adapted to occur dynamically.

One or more options or suggestions may be generated by analogy and may be utilized to create the rules. In this regard, fragments of sales process information may be identified and/or selected to be utilized for generating the rule by analogy. The fragments of sales process information may be identified and/or selected based upon a context associated with the fragment of sales process information. A context such as one inputted by a salesperson may be received and utilized for identifying and/or selecting the fragment of sales process information.

Aspect of the invention for modeling a sales process may be utilized in connection with providing a single consolidated location where sellers may access and acquire sales data and information pertaining to working opportunities required to sell its products offerings. Products may include, but is not limited to, goods, whether tangible or intangible, and services. Real-time links may be provided between any number of sales processes and external systems which may receive and/or distribute sales process information.

Since sales process information may provide business opportunities and may include any information that may be pertinent to creating and maintaining a relationship between a customer or potential customer and a business, it is important to provide a system the may adequately model sales processes. Sales processes information may be classified into a plurality of categories or contexts, which may include, but are not limited to, product offering data, channel data, vertical data, geographical data and customer data. A sales integration engine may eliminate, for example, many of the complexities and time required for connecting and interfacing with myriad of external systems. A sales process configuration system may be adapted to utilize the sales process information provided by the sales integration engine. In order to utilize the sales process information to create a sales process, certain criteria and guidelines are necessary that may dictate how the sales process configuration system operates. In accordance with an embodiment of the invention, a sales process modeling method and system is provided.

Sales processes may form the backbone for a seller's activities while working on opportunities to sell product offering. Sales processes may be modeled to simulate various phases of a sales process selling cycle. These phases may include, but are not limited to, customer needs identification, decision making identification, product and/or service demonstration and return on investment. Each phase may include a series of activities that may have to be completed in order to progress through the sales process selling cycle. In some instances, one or more of the activities in a sales process selling cycle may require certain pre-conditions or contexts be fulfilled before an activity may be completed. Information needed to complete an activity or to satisfy a pre-condition may vary depending on a number of parameters. In an exemplary case where an return on investment (ROI) analysis task is required, some of these parameters may include, but are not limited to, one or more base documents that may be required to create the ROI and the revenue generated over the last fiscal year and/or last quarter. Similarly, exemplary activities may include, but are not limited to, collection of revenue information, illustration of earnings growth and determination of investment growth. Accordingly, aspects of the invention provide a system and method for efficiently fulfilling pre-conditions and activities that may be necessary for completing a sales process selling cycle.

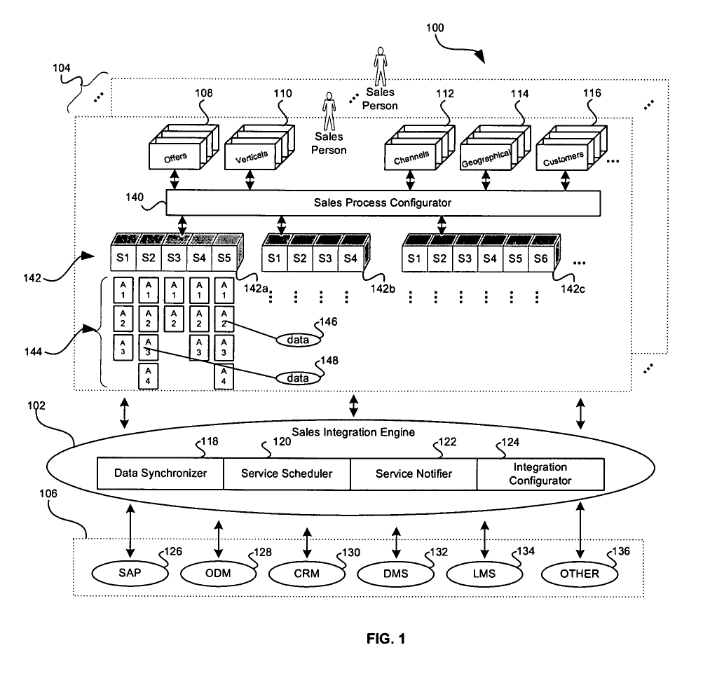

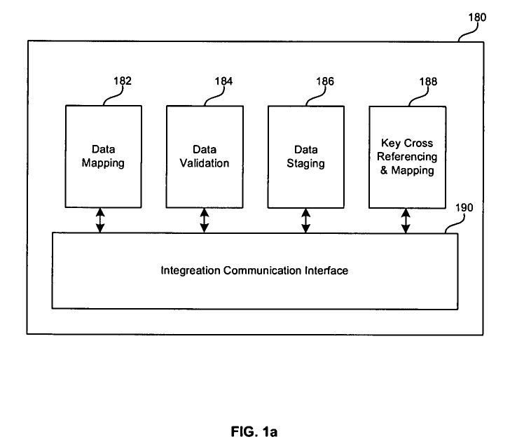

FIG. 1 is a block diagram of sales processing system 100 having an exemplary sales integration engine block 102 in accordance with an embodiment of the invention. Referring to FIG. 1, there is shown a sales integration engine or block 102, customer opportunities and data blocks collectively referred to as 104, and an information resources block 106.

The sales integration engine 102 may be adapted to connect the activities from any number of processes in any context, to any external system, and to send, receive and process sales process information in real-time and/or or at some time subsequent to the acquisition of the sales process information. The sales integration engine 102 may be based on a sales integration framework, which may contain a plurality of sub-components, which may be adapted to provide one or more services necessary to connect to and manage data exchange between one or more sales processes and one or more external systems. Since sales process information required by sellers to access working opportunities in order to sell product offerings may be made available or accessible in one consolidated location, the sales integration engine 102 may remove the complexities and time required for connecting and interfacing with the external systems.

The sales integration engine or block 102 may include a plurality of functional blocks, each of which may be adapted to perform specialized data processing tasks. The exemplary sales integration engine or block 102 of FIG. 1 may include any one or more of a data synchronization block or engine 118, a service scheduler block 120, a service notification block 122, and an integration configurator block 124. In accordance with an embodiment of the invention, the data synchronization block 118 may be adapted to include at least one or more of a data mapping function, a data validation function, a data staging function, a key cross referencing and mapping function, and an integration communication interface that may permit communication with external systems.

FIG. 1a is a block diagram of an exemplary data synchronization block 118 in accordance with an embodiment of the invention. Referring to FIG. 1a, there is shown a data mapping function 182, a data validation function 184, a data staging function 186, a key cross referencing and mapping function 188, and an integration communication interface 190.

The data mapping function 182 of the data synchronization block 118 may be adapted to translate information from a first non-native format to a second format, the latter of which may be interpreted by the sales processing system. In this regard, the data mapping function 182 may include one or more mappers or translators that may be configured to convert information from various non-native formats to a format native to the sales processing system. For example, the data mapping function 182 may be adapted to convert hypertext markup language (HTML) formatted information into extensible markup language (XML) formatted information.

The data validation function 184 of the data synchronization block 118 may be adapted to validate information that has been processed or translated by the mapping function. The data validation function 184 may verify the integrity of the translated information to ensure its accuracy and consistency.

The data staging function 186 of the data synchronization block 118 may include one or more quality approval processes. In one embodiment of the invention, a quality approval process may be adapted to determine whether the information meets certain criteria and/or guidelines. The criteria and/or guidelines may be company based, standards based, industry based, de facto, and/or government based. For example, the quality approval process may ensure that company guidelines have been followed and that standardized processes and procedures such as ISO 9001 have been satisfied.

The key cross referencing and mapping function 188 of the data synchronization block 118 may be adapted to maintain a unique key cross-referencing between external systems and an internal sales processing system. In this regard, subsequent to the synchronization of information by the data synchronization block 118, the key cross referencing and mapping function 188 may be adapted to evaluate the data and determine possible associations that may inter-relate at least portions of the synchronized information.

The integration communication interface 190 of the data synchronization block 118 may be adapted to facilitate communication with one or more of a plurality of disparate and/or external systems. In this regard, the integration communication interface 190 may be adapted to communicate with, for example, an enterprise application integration (EAI) system or server. In accordance with an aspect of the invention, middleware may be utilized to integrate various application programs to ensure that information may be readily interchanged between, for example, databases, legacy systems and disparate systems that my contain relevant sales process data or information.

In a case where it may be necessary to determine whether a particular candidate may be qualified for particular job, the data mapping function 184 may be adapted to select an appropriate candidate from a plurality of candidates. The data validation function 184 may determine whether the candidate has the required qualifications, which may include academic and/or employment experience. The data staging function 186 may determine whether the credentials stated by the candidate are in fact genuine. Subsequent to synchronization of the information, the key cross referencing and mapping function 188 may be adapted to determine how the credentials of the candidate compares to other candidates that might have been hired in the past. In another example, the key mapping and cross referencing 188 function may be adapted to determine how the credentials of the candidate compares to other similar candidates hired by other companies.

The sales integration engine 102 may also include a service scheduler block 120. Since the sales integration engine 102 may communicate with a plurality of other information systems, the service scheduler block 120 may be adapted to control a frequency at which the sales integration engine 102 my acquire and/or update information. For example, the service scheduler 120 may be adapted to query a particular customer information database at intervals, which may include, but are not limited to, every microsecond, every minute, every hour, once per day, once per week or at the end of every month.

A frequency at which the service integration engine 102 may acquire updates may be adaptively altered by the service scheduler 120. Accordingly, the service scheduler 120 may be adaptively configured to instruct the sales integration engine 102 to obtain updates from certain databases or information systems in real-time. For example, the CRM block 130 in the information resources block 106 may be known to continually update its customer database throughout the day while customers call into a CRM call center. With this knowledge, the service scheduler 120 may be adapted to schedule the sales integration engine 102 to acquire information from the CRM block 130 at a frequency of, for example, every ten (10) minutes. In a case where the CRM block 130 may be known to update its customer database only at the close of business during the week, then the service scheduler 120 may be adapted to schedule the sales integration engine 102 to acquire information at midnight every day during the week.

The sales integration engine 102 may also include a service notifier block 122. Since the sales integration engine 102 communicates with a plurality of other systems, the service notifier 122 may oversee the operations of the sales integration engine to determine whether any errors occur in the operations of the sales integration engine 102. The service notifier 122 may be adapted to detect errors in the operations of the sales integration engine 102 without a need for manual intervention. However, the invention may not be limited in this regard and the service notifier block 122 may require manual intervention certain circumstances.

Depending on the type of business entity, various levels of severity of the errors may be defined. The type of business entity may include, but is not limited to, customer information, opportunity information and content related information. A content related business entity may have, for example, ten (10) severity levels, namely severity level one (1) through severity level ten (10). In this regard, severity level one (1) may be the least severe error and severity level ten (10) may refer to the most severe error. Furthermore, depending on the level of severity, notifications may be dispatched to selected sub-subsystems and/or persons.

The sales integration engine 102 may also include an integration configurator 124. In general, the sales integration engine 102 may be designed to be highly configurable. In this regard, the integration configurator 124 facilitates speedy configuration of the sales integration engine 102 to meet the requirements of a particular business application. The integration configurator 124 may include one or more graphical user interfaces (GUIs) that may run on a terminal directly or remotely coupled to the sales processing system. The GUI may provide selectable options that permit the selection of various parameters that may permit one or more of a plurality of operational modes for the sales integration engine 102. The GUI may also permit input of certain parameters that may affect the operation of the sales integration engine 102.

The integration configurator 124 may be configured to permit the sales integration engine 102 to interact with a plurality of systems without the need to engage in software modification. Once new parameters are entered into the integration configurator 124, the data synchronizer 118 may accordingly change the operations of the sales integration engine 102 to operate with the new parameters. Notably, whenever it may be desirable to make changes to the operations of the sales integration engine 102, these changes may be made to via the integration configurator 124. For example, in a case where specialized data may be received from specific ones of a plurality of information systems, the integration configurator 124 may instruct the sales integration engine 102 to acquire information from only those specified information systems.

In certain instances, it may be necessary to orchestrate the sequencing of data from a plurality of information systems. In a case where it may be appropriate to receive data from particular ones of the plurality of information systems prior to receiving data from other ones of the information systems, the integration configurator 124 may be configured to provide the appropriate sequence in which the data should be received. In another aspect of the invention, the integration configurator 124 configures how data may be received and processed. In this case, the integration configurator 124 may configure the sales integration engine 102 to receive incremental changes to a customer record or receive the complete customer record whenever a change has occurred in a customer record. The integration configurator 124 may also be adapted for load balancing of the sales processing system. This may permit changes that dictate where and how particular sales process information may be processed within the system. In order to balance system load, the integration configurator 124 may also be configured to prioritize the execution of certain sales processes. The integration configurator 124 may also be programmed to determine a number of subscribers to which data may be sent and also a number of systems from which data may be received. Furthermore, in another aspect of the invention, metadata required for the data synchronizer to execute its data mapping or translation function may also be stipulated by the integration configurator 124. In this regard, the integration configurator 124 may specify what languages may be necessary for proper translation and mapping.

The customer opportunities and data block 104 may include a sales process configurator 140 and any one or more of a product offerings data block 108, a verticals data block 110, a channels data block 112, a geographical data block 114 and a customers data block 116. The customer opportunities and data block 104 may further include a plurality of sales process or task 142a, 142b, 142c, collectively illustrated as 142. Each of the tasks may have a plurality of steps. For example, sales process or task 142a may include five (5) steps, namely S1, S2, S3, S4, S5. Each of the steps may also include a plurality of activities collectively illustrated as 144. For example, step S1 has activities A1, A2 and A3. At least some of the activities may have pre-requisites or required contents 146, 148.

The information resources block 106 may include, for example, one or more of a SAP block 126, an order management system (ODM) block 128, a customer relationship management (CRM) block 130, a document management system (DMS) block 132, a learning management system (LMS) block 134 and/or other resource block 136.

The SAP block 126 may be an information database that may be adapted to store and process SAP database related information. The order management system block 128 may be adapted to store product order information. The CRM block 130 may include a suite of products that may be integrated to provide the necessary infrastructure for implementing channel for supporting sales process related activities. The CRM block 130 may be adapted to acquire, identify and retain customers. The document management system block 132 may be adapted to store and process sales documents. The learning management system block 134 may be adapted to function as a library system that may contain archived and historical information related to previous sales process transactions.

In the embodiment of the FIG. 1, the sales integration engine or block 102 may include a plurality of interfaces, at least one of which may be coupled to the customer opportunities and data block 104 and another of which may be coupled to the information resources block 106. The sales integration engine or block 102 may be configured to potentially connect any number of sales processes to any one or more of a plurality of external systems, which may contain information required by sellers. Information acquired from the external systems may be relevant to at least one or more of the various data contexts which may be included in the customer opportunities and data block 104, for example product offerings data block 108, verticals data block 110, channels data block 112, geographical data block 114 and customer data block 116. The external systems, may be for example, one or more external servers and/or databases which may store and/or distribute information. The sales integration engine or block 102 may be configured to connect with a plurality of external information systems. In one embodiment of the invention, the information exchange may occur in real-time as changes to data occur.

The offers block 108, verticals block 110, channels block 112, geographical block 114 and customers block 116 may be classified as contexts within the customer opportunities and data block 104. The product offering data block 108 may include, but is not limited to, information such as product and/or service descriptions. A channel may be a particular communication medium or a logical medium that may be used to offer one or more sales activities. The channel context block 112 may define a manner in which a business caters to its customers. This may include, but is not limited to, a telephone based channel, a web based channel, a kiosk based channel, a field based channel, a storefront channel and/or mail order based channel.

In general, the verticals block 110 may refer to the different types of businesses and/or industries to which a particular business may cater. For example, an equipment manufacturer may cater to verticals including, finance, manufacturing, resellers, legal, and retail. The customer context block 116 may define the spectrum of actual and potential customers. The geographical context may include information pertaining to the location of a customer. Additionally, the geographical context may also include information pertaining to customer demographics.

The customer opportunities and data block 104 may include various sales processes or tasks 144, each of which may have a number of steps. For example, sales process or task 142a is shown having five steps, namely S1, S2, S3, S4, S5. Step S1 of sales process 142a has three (3) activities, namely A1, A2, A3. Step S2 of sales process 142a has four (4) activities, namely A1, A2, A3, A4. Step S3 of sales process 142a has two (2) activities, namely A1, A2. Step S4 of sales process 142a has three (3) activities, namely A1, A2, A3. Finally, step S5 of sales process 142a has four (4) activities, namely A1, A2, A3, A4. Activity A3 of step S2 requires prerequisite data or content 148 and activity A2 of step S5 requires prerequisite data 146. Accordingly, the prerequisite data or content 148 may be required for the completion of activity A3. Similarly, the prerequisite data or content 146 may be required for the completion of activity A2. Each of the activities for a particular task may require information from an external information system. The required information may be external to the sales integration system 102. In accordance with the invention, a collection of steps and activities and any perquisite data or content may form a sales process.

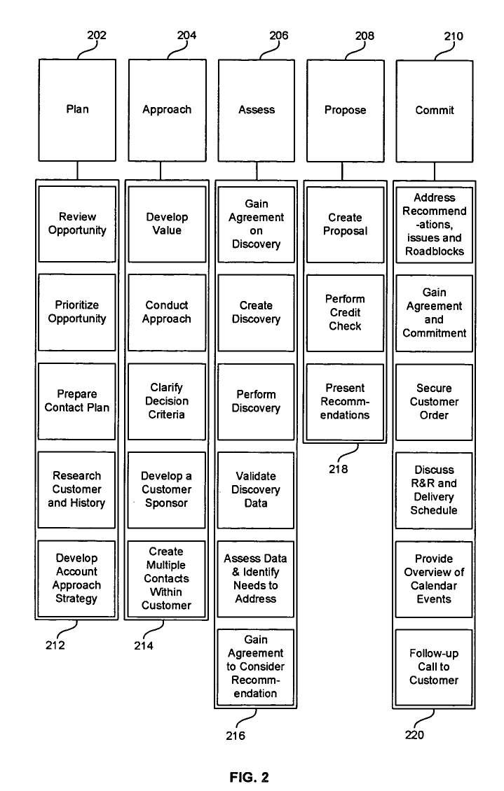

FIG. 2 is a block diagram of an exemplary sales process in accordance with an embodiment of the invention. Referring to FIG. 2, there is shown a plurality of steps, namely plan step 202, approach step 204, assess step 206, propose step 208 and commit step 210. Each of steps 202, 204, 206, 208, 210 may include one or more activities.

The plan step 202 may have five (5) activities, collectively referenced as 212. These activities 212 may include a review opportunity activity, prioritize opportunity activity, a prepare contact plan activity, a research customer and history activity and finally, a develop account approach strategy. The review opportunity activity may include a review of some or all the relevant issues related to the sales opportunity. The prioritize opportunity activity may include prioritizing the relevant issues and tasks involved with the sales opportunity. The prepare contact plan activity may include preparing a list of possible contacts and the roles and extent to which each contact might be involved. The research customer and history activity may include doing various searches in order to acquire information that may provide a synopsis of the company, including its history and performance. Varying levels searching may be done depending on the depth and breadth of the information required. The develop account approach strategy activity may include developing a feasible account approach strategy.

The approach step 204 may have five (5) activities, collectively referenced as 214. These activities 214 may include a develop value activity, a conduct approach activity, a clarify decision criteria activity, a develop a customer sponsor activity and finally, a create multiple contacts within customer activity. The develop value activity may include creating a strategy on how best to approach a customer and how best to deliver a plan to the customer. The conduct approach activity may include strategizing how best to build customer awareness and stimulate a customer's interest. The develop customer sponsor activity may include the development of a sponsor efforts within a customer's environment to support sales related activities. The create multiple contacts within customer activity may include ascertaining which contacts within, for example a company, may be beneficial to the sales opportunity.

The assess step 206 may have six (6) activities, collectively referenced as 216. These activities 216 may include a gain agreement on discovery activity, a create discovery activity, a perform discovery activity, a validate discovery activity, an assess data and identify need to address activity and finally, a gain agreement to consider recommendation activity. The gain agreement on discovery activity may include determining the scope and nature of the agreement and the parties and/or entities that may be involved in any agreement effort. The create discovery activity may include, for example, the creation of a questionnaire. The validate discovery data activity may include the step of validating and verifying the content of any material discovered. Since the perform discovery activity may be a critical activity to the assess step 206, the perform discovery activity may be denoted as a mandatory activity. The assess data and identify need to address activity may include identifying customer needs and formulating how best to satisfy those needs. The gain agreement to consider recommendation activity may include gaining agreement on acceptance on any recommendations that may be made.

The propose step 208 may have three (3) activities, collectively referenced as 218. These activities 218 may include a create proposal activity, a perform credit check activity, and finally, a present recommendations activity. The create proposal activity may include the creation of various proposals and recommendation pertinent to the sales strategy. Since the perform credit check activity may be a critical activity to the propose step 208, the perform credit check activity may be denoted as a mandatory activity. The present recommendations activity may include the presentation of recommendations to key decision makers and players related to the sales opportunity and/or activity.

The commit step 210 may have six (6) activities, collectively referenced as 220. These activities 220 may include an address recommendations, issues and roadblocks activity, a gain agreement and commitment activity, a secure customer order activity, a discuss recommendations, road blocks and delivery schedule activity, a provide overview of calendar events activity and finally, a follow-up call to customer activity. The address recommendations, issues and roadblocks activity may include deciding how best to handle roadblocks that have been encountered or may be encountered. The gain agreement on discovery activity may include finalizing the scope and nature of the agreement with the parties and/or entities involved in the agreement effort. The secure customer order activity may include acquiring an order for certain products and/or services from the customer. The discuss recommendations, road blocks and delivery schedule may include discussing any roadblocks that may be encountered or will be encountered during delivery of the product and/or service. The provide overview of calendar events activity may include creating a timeline of the events related to the sales process. For example, a timeline may be created to track the deliverables. Since the follow-up call activity may be a critical activity to the commit step 210, the follow-up call to customer activity may be denoted as a mandatory activity.

In operation, the sales integration engine 102 may, within the contexts of offers 108, verticals 110, channels 112, geographical 114 and customers 116, for a specific sales process, for a particular activity within the sales process, acquire pertinent information from a resource in the information resources block 106 in real-time.

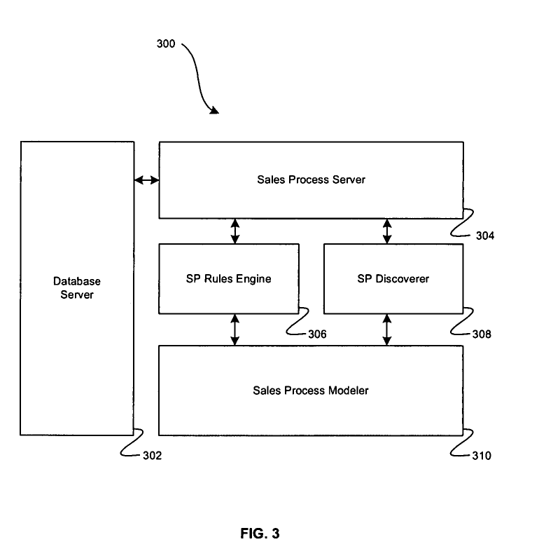

FIG. 3 is a block diagram 300 of an exemplary sales process configurator that may be utilized for sales process configuration in accordance with an embodiment of the invention. Referring to FIG. 3, there is shown a database server 302, a sales prices server 304, a sales process rules engine 306, a sales process discoverer 308 and a sales process modeler 310.

The database server 302 may be any conventional database server that may be utilized for storing information. In this regard, the database server 302 may be adapted to store sales process information.

The sales process server 304 may be a server having specialized sales processing software that may be adapted for sales process configuration. The sales process server 304 may be coupled through a suitable interface to the database server 302.

The sales process rules engine 306 may be coupled to the sales process server 304. The sales process rules engine 306 may include one or more applications that may be adapted to run on the same host as the sales process server 304. However, the invention is not limited in this regard and the sales process rules engine 306 may be adapted to run on a host machine externally coupled to the sales process server 304.

The sales process discoverer 308 may be coupled to the sales process server 304. The sales process discoverer 308 may include one or more applications that may be adapted to run on the same host as the sales process server 304. However, the invention is not limited in this regard and the sales process discoverer 308 may be adapted to run on a host machine externally coupled to the sales process server 304.

The sales process modeler 310 may be coupled to the sales process server 304. The sales process modeler 310 may include one or more applications that may be adapted to run on the same host as the sales process server 304. However, the invention is not limited in this regard and the sales process modeler 310 may be adapted to run on a host machine externally coupled to the sales process server 304.

In operation, the sales process server 304 may be adapted to receive certain sales process information pertaining to a sales opportunity from a salesperson. In this regard, a GUI may be provided by the sales process server 304, which may be adapted to permit the salesperson to select and/or enter the sales process information. In an alternate embodiment, the sales process server 304 may be adapted to process certain scripts that may contain information related to the sales process information. The information contained in the sales process information may relate to the various sales contexts. These sales contexts may include, but are not limited to, offer, vertical, customer, channel, and geography. Based on a content of the sales process information inputted by the salesperson and/or a sales process script, the sales process rules engine 306 may select appropriate rules that best fits the sales process information for particular contexts.

In general, requirements for various stages of sales processing may vary depending on, for example, the sales contexts, the type of business and the experience of the salesperson. Accordingly, the sales process discoverer 308 may be adapted to discover and establish relevant information and rules related to, for example, the sales context, type of business and the experience of the salesperson. The sales process discoverer 308 may be required to determine a best fit for the sales process information entered by the salesperson and/or sales process script. The sales process discoverer 308 may, in certain circumstances, be required inputted sales process information a generated sales process.

The sales process modeler 310 may be configured to ascertain pertinent information related to the inputted sales process information required to generate a sales process for the salesperson. If, based on the input provided by the salesperson and/or sales process script, there are adequate rules to provide a best fit for the sales process information, the sales process server 304 may generate an appropriate sales process. The sales process generated by the sales process server 304 may be adapted to have certain confidence scores and/or levels based on a fit between the sales process information and the sales process rules provided or generated by the sales process rules engine 306. For example, if there is a direct fit between the inputted or selected sales process information and the rules provided by the sales process rules engine 306, then the confidence score may be about 100%. However, in a case where there may be no fit between the entered sales process information and the rules provided by the sales process rules engine 306, then the confidence score may be about 0%. In accordance with an aspect of the invention, there may be varying levels of confidence scores ranging between 0% and 100% depending on the fit between the inputted or selected sales process information and the rules provided by the sales process rules engine.

Although there may be pertinent information stored in the database server 302, there may be cases where there is no pertinent information or sales process rules available. In this case, the sales process modeler 310 may be adapted to generate appropriate information by analogy. Once the information is generated by the sales process modeler 310, the sales process rules engine may use the information generated by the sales process modeler 310 to generate appropriate rules. In this manner, the sales process server may utilize the rules from the sales processing engine to generate an appropriate sales process based on the input provided by the salesperson and/or the sales process script. Additionally, the sales process modeler 310 may be adapted to generate suggestions and/or what-if scenarios in order to create an appropriate fit.

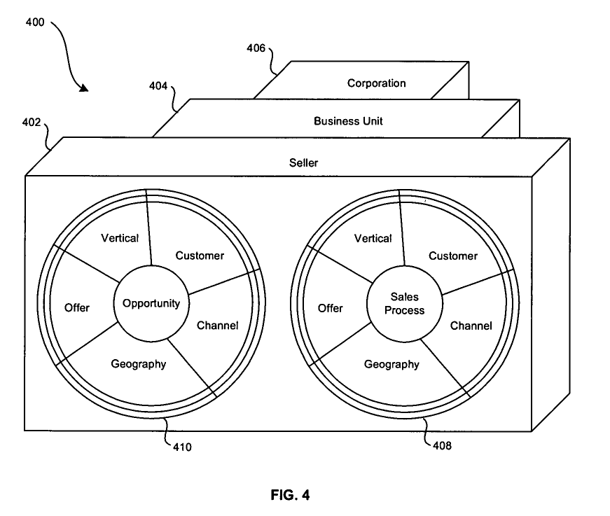

FIG. 4 is a block diagram 400 of an exemplary sales process configurator that may be utilized for sales process configuration system in accordance with an embodiment of the invention. Referring to FIG. 4 there is shown a sales process 408, a sales opportunity 410, a seller entity level 402, a business unit entity level 400 and a corporation entity level 404.

In operation, referring to the opportunity block 410, a salesperson may use any one or more of the contexts, for example, offer, customer, vertical, channel and geography to create an opportunity. In the sales process block 408, the sales process configuration system may be adapted to use any one or more of the various contexts, for example, offer, customer, vertical, channel and geography, inputted by a salesperson or sales process script, to generate a sales process. Any combination of contexts for any particular sales process may be classified as a rule. For example, a rule may be defined for a particular sales process having a particular vertical and a particular offer. In another example, a rule may be defined for a particular channel and a particular geography. Additionally, defined rules may be interrelated so that portions of the contexts used to create a rule may be utilized by another rule. Accordingly, a specific rule may be utilized by one or more similar sales processes or for different sales processes. For example, a first rule may be defined using a particular channel and geography. A second rule may be defined using the same particular channel but with a particular vertical. A third rule may be defined using the same particular channel as the first rule, the same particular vertical as the second rule and with a new customer.

The block diagram 400 illustrates an embodiment of the invention wherein a sales process configuration system may be adapted to process sales process information on a hierarchical level. Accordingly, various rules defined by a sales process rules engine may be categorized according to, for example, a seller entity level 402, a business unit entity level 404 and a corporation entity level 406. In this regard, the seller entity level 402, the business unit entity level 404 and the corporation entity level 406 may be viewed as contexts. Hence, rules may be defined at the seller entity level 402, at the business unit entity level 404 and at the corporation entity level 406.

In an embodiment of the invention, there may be various sub-levels within a particular level. For example, various skills levels may be included within the business unit level 404. A salesperson having a particular set of skills may be given a particular sales process, but if the same person wishes to utilize a different set of skills, then the sales process configuration system may assign a totally different sales process. For example, a salesperson highly skilled in selling widgets may be assigned a particular sales process. However, if the same salesperson now chooses to sell bricks, then the sales process configuration system may be adapted to provide a different sales process since the salesperson has had no experience selling bricks. In another aspect of the invention, the sales process configuration system may be further adapted to determine similarities between selling widgets and blocks, and/or the salespersons experience and accordingly provide a suitable sales process.

The sales process configuration system may be adapted to model sales processes based on various parameters that may be used to define a sales opportunity. Notwithstanding, the sales process configuration system may be adapted to rely on various models that may dictate the selection and best fit for a sales process. In this regard, the sales process modeler 310 may be adapted to generate various sales models and related sales information and data that may facilitate the creation of an appropriate sales process. The use of sales process modeling may remove the complexity of creating and strategizing sales efforts from the salesperson. Accordingly, those eighty percent (80%) of salespersons that contribute to twenty percent (20%) of the profits may now have the capability to perform like those salespersons in the top twenty percent tier.

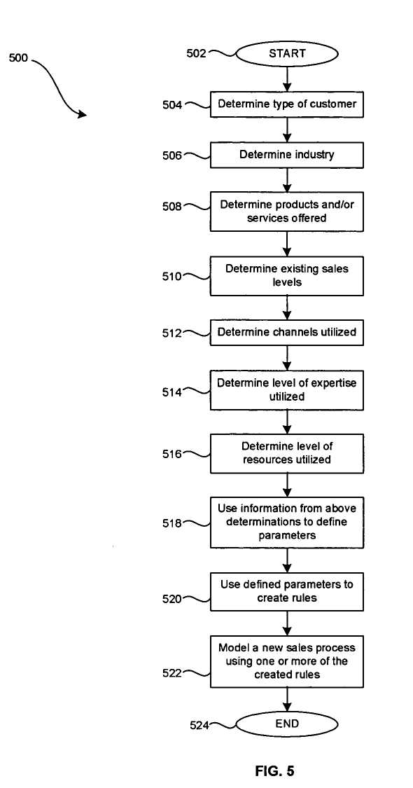

FIG. 5 is a flow chart illustrating exemplary steps outlining the operations of a sales process modeler in accordance with an embodiment of the invention. Referring to FIG. 5, the steps may be initiated at start step 502. In step 504, the type of customer may be determined. In step 506, the type of industry may be determined. In step 508, the products and/or services offered may be determined. In step 510, existing sales levels may be determined. In step 512, the channels utilized may be determined. In step 514, the level of expertise utilized may be determined. In step 516, the level of resources utilized may be determined. In step 518, the information gathered from at least some of steps 504, 506, 508, 510, 512, 514 and 516 may be utilized to define various parameters, Accordingly, based on the information gathered in any one or more of steps 504, 506, 508, 510, 512, 514 and 516, values may be assigned to the defined parameters. In step 520, the defined parameters along with their values may be used to define rules. In step 522, one or more of the created rules may be used to model a new sales process. The steps end with step 524.

In accordance with an embodiment of the invention, the sales process modeler 310 of FIG. 3 may be configured to dynamically collect parameters for various sales process information and adaptively create rules that may be utilized to create a sales process. For example, in a case where there may be no historical information available to create a sales process, the sales process modeler 310 may be adapted to query a salesperson for additional information and accordingly generate rules based on the query. The rules may subsequently be utilized to create or generate various activities and/or steps during the creation of a sales process.

In an embodiment of the invention, the sales process modeler 310 may be adapted to provide or generate one or more options and/or suggestions by analogy, which may be utilized to create rules related to various contexts. In this regard, the sales process modeler 310 may look for fragments of sales process information that may have some relation to inputted sales process information. For example, the sales process modeler 310 may be adapted to utilize a fuzzy logic algorithm to identify fragments of rules that may be applicable to at least portions of the sales process information. Although rules may be dependent on a given contexts, certain rules may be designated as being universal and may be adapted to be generic to a plurality of contexts. Hence, a created rule may be generic or it may be specific.

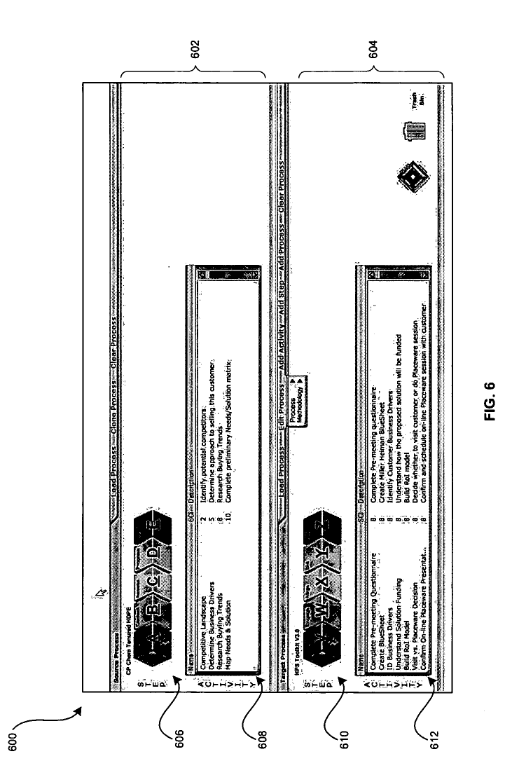

FIG. 6 is an exemplary GUI 600 illustrating manual copying of activities and steps for sales process modeling in accordance with an aspect of the invention. Referring to FIG. 6, there is shown a source sales process 602 and a target or destination sales process 604. The source sales process 602 may comprise a plurality of steps collectively illustrated as 606. In this regard, the source sales process 602 may comprise the following exemplary steps: plan A, contact B, assess C, propose D and close E. The source sales process 602 may also include a plurality of activities collectively illustrated as 608.

The destination sales process 604 may also comprise a plurality of steps collectively illustrated as 610. In this regard, the destination sales process 604 may comprise the following exemplary steps: qualify V, engage W, align X, bid Y and win Z. The destination sales process 604 may also include a plurality of activities collectively illustrated as 612. In operation, anyone or more of the source steps 606 and/or activities 608 may be copied from the source process 602 to the target process 604. In this regard, a salesperson may copy or cut appropriate steps and/or activities from one or more opportunities that match certain criteria and paste them in a destination sales process for another opportunity. It should be recognized that FIG. 6 is intended to illustrate only one aspect of the invention and does not limit the invention to the manual generation of sale activities and steps by copying and pasting.

The GUI 600 additionally illustrates a plurality of processing options that may be utilized to generate a sales process. For example, for the source processes 602, there is illustrated a load process option, a clone process option and a clear process option. For the destination or target process 604, there is illustrated a load process option, an edit process option, an add activity option, an add step option, an add process option and a clear process option. Each of the options corresponding to the source process 602 and the destination or target process 604 may comprise one or more sub-options. For example, the edit process option may comprise a process sub-option and a methodology option sub-option.

During copying of activities and/or step from the sources process 604 to the target process 604, intelligence in the GUI 600 may prevent copying and/or pasting of rules that may conflict or are in some manner inappropriate. Notwithstanding, the GUI 600 may also allow various rules to be created in order to model, for example, what-if scenarios.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for modeling sales processes, the method comprising:
acquiring sales process information from at least one existing business model;
defining at least one parameter that characterizes at least one best practice related to said at least one existing business model;
creating at least one rule based on said at least one defined parameter identifying said at least one best practice; and
modeling a new sales process using said at least one created rule.

2. The method according to claim 1, wherein said modeling further comprises adaptively combining rules from a plurality of best practices and at least one manual input to execute said modeling of said new sales process.

3. The method according to claim 1, wherein said at least one created rule is a generic rule applicable to a plurality of contexts.

4. The method according to claim 1, wherein said at least one created rule is applicable to a particular context.

5. The method according to claim 1, further comprising:
receiving at least one real-time update from at least one information source; and
modifying at least of one said created rule based on at least a portion of said real-time update.

6. The method according to claim 5, further comprising dynamically modifying said at least one of said created rule in real-time.

7. The method according to claim 1, further comprising generating by analogy, at least one option or suggestion which may be utilized for said creating of said at least one rule.

8. The method according to claim 7, further comprising identifying and selecting at least one fragment of sales process information to be utilized for said generating by said analogy.

9. The method according to claim 8, further comprising identifying and selecting said at least one fragment of sales process information based on a context associated with said at least one fragment of sales process information.

10. The method according to claim 8, further comprising receiving at least one input received context for said identifying and selecting of said at least one fragment of sales process information.

11. A machine readable storage, having stored thereon a computer program having at least one code section for modeling sales processes, the at least one code section executable by a machine for causing the machine to perform the steps comprising:
acquiring sales process information from at least one existing business model;
defining at least one parameter that characterizes at least one best practice related to said at least one existing business model;
creating at least one rule based on said at least one defined parameter identifying said at least one best practice; and
modeling a new sales process using said at least one created rule.

12. The machine readable storage according to claim 11, further comprising code for adaptively combining rules from a plurality of best practices and at least one manual input to execute said modeling of said new sales process.

13. The machine readable storage according to claim 11, wherein said at least one created rule is a generic rule applicable to a plurality of contexts.

14. The machine readable storage according to claim 11, wherein said at least one created rule is applicable to a particular context.

15. The machine readable storage according to claim 11, further comprising code for:
receiving at least one real-time update from at least one information source; and
modifying at least of one said created rule based on at least a portion of said real-time update.

16. The machine readable storage according to claim 15, further comprises code for dynamically modifying said at least one of said created rule in real-time.

17. The machine readable storage according to claim 11, further comprising code for generating by analogy, at least one option or suggestion which may be utilized for said creating of said at least one rule.

18. The machine readable storage according to claim 17, further comprising code for identifying and selecting at least one fragment of sales process information to be utilized for said generating by said analogy.

19. The machine readable storage according to claim 18, further comprising code for identifying and selecting said at least one fragment of sales process information based on a context associated with said at least one fragment of sales process information.

20. The machine readable storage according to claim 18, further comprising code for receiving at least one input received context for said identifying and selecting of said at least one fragment of sales process information.

21. A system for modeling sales processes, the system comprising:
a sales process server that acquires sales process information from at least one existing business model;
said sales process server defines at least one parameter that characterizes at least one best practice related to said at least one existing business model;
a sales process rules engine that creates at least one rule based on said at least one defined parameter identifying said at least one best practice; and
a sales process modeler that models a new sales process using said at least one created rule.

22. The system according to claim 21, further comprising a sales process discoverer that adaptively combines rules from a plurality of best practices and at least one manual input to execute said modeling of said new sales process.

23. The system according to claim 21, wherein said at least one created rule is a generic rule applicable to a plurality of contexts.

24. The system according to claim 21, wherein said at least one created rule is applicable to a particular context.

25. The system according to claim 21, wherein said sales process server:
receives at least one real-time update from at least one information source; and
a sales process rules engine modifies at least of one said created rule based on at least a portion of said real-time update.

26. The system according to claim 25, wherein said sales process rules engine dynamically modifies said at least one of said created rule in real-time.

27. The system according to claim 21, wherein a sales process rules engine generates by analogy, at least one option or suggestion which may be utilized for said creating of said at least one rule.

28. The system according to claim 27, wherein a sales process discoverer identifies and selects at least one fragment of sales process information to be utilized for said generating by analogy.

29. The system according to claim 28, wherein at least one of said sales process discoverer and said sales process engine identifies and selects said at least one fragment of sales process information based on a context associated with said at least one fragment of sales process information.

30. The system according to claim 28, wherein said sale process server receives at least one input received context for said identifying and selecting of said at least one fragment of sales process information.
